(19) United States
(12) Patent Application Publication
(10) Pub. No.: US 2007/0125178 A1
(43) Pub. Date: Jun. 7, 2007

(54) Liquid metal capacitively monitored sensors

(76) Inventors: Steven A. Rosenau, Mountain View, CA (US); Timothy Beerling, San Francisco, CA (US); Michael Louis Frank, Menlo Park, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/297,019

(22) Filed: Dec. 7, 2005

(51) Int. Cl. G01L 9/12

(52) U.S. Cl. 73/724

(57) ABSTRACT

Capacitive sensors using liquid metals can be fabricated using MEMS device design and fabrication techniques. Movement of the liquid metal in response to a stimulus can provide measurable changes in capacitance of the devices.

### BACKGROUND

Numerous devices use one or more sensors to detect, monitor, and/or measure physical phenomena associated with the devices, aspects of the environment in which devices are operated, or the manner in which the devices are operated. As these devices become more complex, feature-rich, and in some cases more portable, limits on sensor size and resource requirements are becoming more strict. Many of these sensors are built into devices demanding low power consumption, varying duty cycles, robust operation, and long-term stability.

### SUMMARY

Capacitive sensors using liquid metals can be fabricated using MEMS device design and fabrication techniques. Movement of the liquid metal in response to a stimulus can provide measurable changes in capacitance of the devices.

### BRIEF DESCRIPTION OF THE DRAWINGS

FIGS. 1A-1E illustrate several different embodiments in accordance with the invention of liquid metal capacitively monitored pressure sensors.

FIGS. 2A-2B illustrate still other embodiments in accordance with the invention of liquid metal capacitively monitored pressure sensors.

FIGS. 3A-3B illustrate a capacitively monitored temperature sensor that can be further implemented using the architectures illustrated in FIGS. 1A-1E.

### DETAILED DESCRIPTION

The following sets forth a detailed description of the best contemplated mode for carrying out the invention. The description is intended to be illustrative of the invention and should not be taken to be limiting.

Throughout this application, reference will be made to various MEMS device fabrication processes and techniques which will be well known to those having ordinary skill in the art. Many of these processes and techniques are borrowed from semiconductor device fabrication technology, e.g., photolithography techniques, thin film deposition and growth techniques, etching processes, etc., while other techniques have been developed and/or refined specifically for MEMS applications. Additionally, the presently described devices and techniques focus on the use of liquid metal in capacitively monitored sensors. Examples of suitable liquid metals include mercury, gallium alloys, and indium alloys. Other examples of suitable liquid metals, e.g., with acceptable conductivity, stability, and surface tension properties, will be known to those skilled in the art. In still other examples, at least some of the presently described devices can be used with certain liquid dielectrics instead of liquid metals. Although many of the embodiments in accordance with the invention will be described as using liquid metal droplets, at least some of those embodiments can also use liquid dielectrics as will be described in greater detail below.

Use of liquid metal (and in some cases liquid dielectrics) droplets or slugs in the devices disclosed in the present application can address various reliability problems associated with capacitively monitored sensors. In general, movement of the droplet or slug occurs in response to the sensor stimulus. Liquid metal devices are generally free of mechanical wear problems associated with the use of solid mechanical members (e.g., diaphragms, beams, etc.) in MEMS sensors. Vibrations encountered by the sensors will generally dampen out quickly, particularly with smaller liquid metal droplets. Vibrations on the surface of liquid metal droplets generally do not cause signal bounce as long as electrode contacts remain wetted.

MEMS techniques are particularly useful for constructing capacitive sensors because they allow for the construction of compact yet sensitive moving parts. Capacitive techniques are generally less noisy than many other sensor techniques, such as those based on piezoresistance, since they are not susceptible to thermal noise. However, micromachined capacitive devices typically have very small capacitance values, e.g., on the order of 10⁻¹⁵ to 10⁻¹⁸ farads, and so care may be needed in selecting suitable signal recovery circuitry.

As noted above, the basic architecture of capacitive sensors can be conceptually simple, and generally rely on determining a change in capacitance as some portion of the capacitive sensor (e.g., portions corresponding to one or more capacitor electrodes or the capacitor dielectric) moves or changes. Capacitive sensors are generally characterized by certain nonlinear behavior and temperature dependence, but these effects can often be accommodated by careful design and/or integration of suitable signal conditioning circuitry close to the sensor. For example, the capacitance of a simple parallel plate capacitor structure (ignoring fringing fields and other effects) is given by

$$C = \frac{{ɛ}_{0} {ɛ}_{r} A}{d} ,$$

where ε₀ is the permittivity of free space, εᵣ is the relative permittivity of the dielectric material between the electrodes, A is the area of overlap between the electrodes, and d is the distance between the electrodes.

The expression describing capacitance demonstrates that the capacitance can be varied by changing one or more of the other variables. In an example, one electrode of the capacitor fabricated in a fixed position, while the other electrode is allowed to move in response to some stimulus. The movement of the electrode can be configured such that it moves toward or away from the fixed electrode, thereby varying the separation d, and changing the capacitance inversely. If instead electrode movement is lateral, the value of d remains constant, but the area of overlap A changes, producing a linear change in capacitance. In still another example, the electrodes remain in a fixed position, and the dielectric material between the electrodes is allowed to move or change, thereby changing the capacitance by altering the effective permittivity of the material between the electrodes.

While a parallel plate capacitor provides a useful example, capacitive sensors need not be constructed so as to strictly adhere to this architecture. Thus, numerous capacitive devices and geometries can be implemented including, for example, differential capacitance sensors (useful for canceling out other effects like temperature dependence), sensors with more than two electrodes, sensors where one or both of the electrodes are formed by liquid metal droplets or slugs whose flow (and therefore relative position) effect capacitance, sensors where the capacitor plates are co-planar and situated next two each other, and the like.

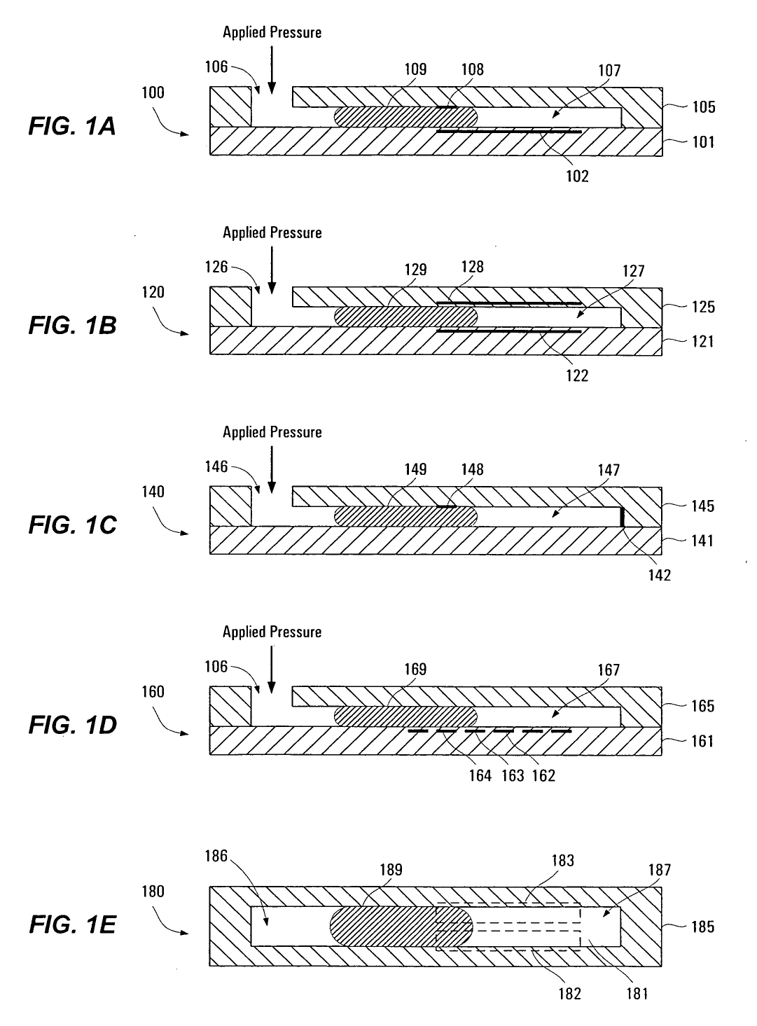

FIGS. 1A-1E illustrate several different embodiments of capacitively monitored pressure sensors. In each of the examples illustrated, a cavity in the capacitively monitored pressure sensor is designed to include a liquid metal droplet. In most cases cavity formation is not complete until two separate structures are bonded together. For example, various electrodes, heaters, insulators, coatings, and cavity features, and other circuit/MEMS devices can be fabricated on a first semiconductor wafer (e.g., silicon) using conventional semiconductor processing techniques. The remainder of the cavity structure (e.g., a cavity roof, lid, or enclosure) can be fabricated on a second wafer, and the two wafers aligned and bonded to form the complete structure. Numerous well known wafer bonding techniques, such as anodic bonding, fusion bonding, glass frit bonding, adhesive bonding, eutectic bonding, microwave bonding, thermocompression bonding, and solder bonding, can be used. Although the examples in accordance with the invention emphasize devices formed from two separate, bonded layers, sufficiently enclosed capacitively monitored sensor cavities can be fabricated on a single wafer, and thus the presently described devices and techniques have equal applicability.

As shown in FIG. 1A, capacitively monitored pressure sensor 100 is formed from two separate material layers 101 and 105. In this case, each of material layers 101 and 105 are separate wafers (or portions thereof) that have been bonded together. For simplicity of illustration, numerous structures and features, such as various additional electrodes, vents, circuitry, etc. used in loading and operating the capacitively monitored pressure sensor, have been omitted from the figure. Capacitively monitored pressure sensor 100 is shown in cross-section. The cross section shown is illustrative of the sensor's length, revealing pressure inlet 106 and fluidic channel 107. Liquid metal droplet 109 is placed within fluidic channel 107, and generally moves in response to an applied pressure through inlet 106 and/or a back-pressure provided by a gas located within channel 107 and between liquid metal droplet 109 and the end wall of the channel. Fluidic channel 107 provides a path along which liquid metal can be introduced and transported. These channels or cavities are typically surrounded on all sides by walls, with the exception of inlet 106. As will be known to those skilled in the art, various different techniques (e.g., vapor deposition, nozzle injection, etc.) can be used to place liquid metal droplet 109 in channel 107, and various device features (e.g., vents, loading reservoirs, heaters, etc.) can be included to facilitate that process. Thus, depending design and fabrication choices, sensor 100 can be loaded with liquid metal droplet 109 either before or after material layers 101 and 105 are bonded together.

Capacitively monitored pressure sensor 100 includes two electrodes 108 and 102. For convenience, coupling traces to control circuitry and/or measurement circuitry are not shown. Electrode 108 is formed to at least partially extend into channel 107 and make electrical contact with liquid metal droplet 109. Electrode 102 is generally insulated from direct electrical contact with liquid metal droplet 109, e.g., using an intervening insulating layer or the like. As the fluid whose pressure is being measured enters through inlet 106, it pushes liquid metal droplet 109 toward the end of channel 107. Since liquid metal droplet 109 is in contact with electrode 108, the combination operates as a moving electrode in the capacitor formed with electrode 102 and intervening dielectric material. In this configuration, the vertical gap (d) between the electrodes does not change, but the area A of overlap between the electrodes does change with applied pressure. Sensor 100 is typically calibrated so that a change in capacitance corresponds to a known applied pressure. Electrodes 102 and 108 can be fabricated from any suitable conductor(s) compatible with surrounding materials and fabrication techniques. For example, depending on the choice of material for liquid metal droplet 109, certain conductors may need to be selected for electrode 108 such that it is not readily absorbed or amalgamated with liquid metal of droplet 109.

Capacitively monitored pressure sensor 100 is generally fabricated so that a gas resides in the portion of channel 107 between droplet 109 and the end wall. Such gas will generally be necessary to provide pack-pressure to help “reset” the position of liquid metal droplet 109 when the applied pressure returns to an ambient pressure value for which the sensor is designed, and to otherwise help keep the droplet in desired regions of channel 107. In some embodiments in accordance with the invention, suitable gases will typically be inert (e.g., nitrogen, argon, etc.) so that they do not react with or diffuse into liquid metal droplet 109 or other surrounding materials. In still other embodiments in accordance with the invention, reducing gases can be used to help remove, for example, oxygen from the liquid metal droplet. This might be particularly useful for metals or alloys (e.g., gallium alloys) that oxidize easily. The back-pressure gas is typically introduced at the time of metal droplet loading, but can instead be inserted, e.g., via a vent that is subsequently plugged, after the droplet is loaded.

As will be understood by those skilled in the art, the size, shape, and relative location of the various sensor components (e.g., channel 107, electrodes 108 and 102, droplet 109, and inlet 106) can be adjusted depending on the needs of the device. For example, the size and location of electrode 108 might depend at least in part on the desired size of liquid metal droplet 109. Since electrode 108 should always be able to contact droplet 109 thereby maintaining contact with one of the capacitor's “plates” during operation, electrode 108 might be relatively small in terms of surface area, but located at the approximate center of the droplet's range of motion. Similarly, although FIG. 1A does not illustrate the extent of channel 107, electrode 102 or electrode 108 into or out of the page, various different configurations can be implemented. One or both of electrodes 108 and 102 might be designed to have a width comparable to that of the channel. In other implementations, the electrodes can be wider than or narrower than the channel, and have various shapes. In general, the size, shape, and location of many of these components is driven, at least in part, by the desire to have relatively high capacitance values (e.g., for ease of measurement) and stable changes in those capacitance values as applied pressure changes. Thus, many design considerations will be driven by capacitance measurement parameters and techniques.

Additionally, the type of fluid whose pressure is being measured and the manner in which sensor 100 is subjected to the fluid can also drive sensor design considerations. In general, the application of pressure to the sensing element (e.g., liquid metal droplet 109) causes deflection or movement of the liquid metal droplet, and that movement can be used to determine the magnitude of the applied pressure. For static fluids, the pressure at a given point within the fluid occurs due to the force of the fluids applying pressure. While gases (such as those in the channel region of trapped gas) are compressible, liquids are nearly incompressible. Thus, certain designs for sensor 100 may take further advantage of this incompressibility, e.g., following Pascal's principle that a liquid can transmit an external pressure applied in one location to other locations within an enclosed system. For example, the size or shape of inlet 106 can be different from that of channel 107 to provide some further mechanical advantage, e.g., more sensitive displacement of droplet 109 to provide greater variation in capacitance. Similarly, the size and shape (both in the dimension shown and in cross-section across the width) of channel 107 can be designed to take advantage of known mechanical principles associated with fluid dynamics.

Since controlling the position of liquid metal droplet 109 is important to proper operation of capacitively monitored sensor 100, various material features, devices, and techniques can be used to control the wettability of different portions of channel 107, thereby affecting the flow properties of droplet 109. For example, one or more of the surfaces of channel 107 can include one or more defined areas that alter and/or define the contact angle between liquid metal droplet 109 and channel 107. The contact angle, sometimes referred to as the wetting angle, is a quantitative measure of the wetting of a solid by a liquid. It is defined geometrically as the angle formed by a liquid at the three phase boundary where a liquid, gas and solid intersect. The contact angle is a function of the liquid's surface tension and the surface free energy of the substrate. In general, the contact angle between a conductive liquid and a surface with which it is in contact ranges between 0° and 180° and is dependent upon the material from which the droplet is formed, the material of the surface with which the droplet is in contact, and is specifically related to the surface tension of the liquid. A high contact angle is formed when the droplet contacts a surface that is referred to as relatively non-wetting, or less wettable. A more wettable surface corresponds to a lower contact angle than a less wettable surface. An intermediate contact angle is one that can be defined by selection of the material covering the surface on which the droplet is in contact and is generally an angle between the high contact angle and the low contact angle corresponding to the non-wetting and wetting surfaces, respectively.

For example, it may be desirable to prevent liquid metal droplet 109 from traveling past the end of electrode 102 in the direction away from inlet 106, while ensuring that droplet 109 is free to move in other regions of the channel. Thus, portions of channel 107 can be defined to be wetting, non-wetting, or to have an intermediate contact angle. Portions of channel 107 extending past electrode 102 can be less, or non-wetting to prevent droplet 109 from entering these areas. Similarly, the portion of channel 107 in the vicinity of electrodes 108 and 102 (and perhaps further toward inlet 106) can be defined to create an intermediate contact angle or to be very wettable. Portions of channel 107 in the vicinity of inlet 106 may be non-wettable or inhibiting so as to reduce the chance that liquid metal droplet 109 escapes the channel. As will be known in the art, surface wettability can be controlled, at least in part, by careful selection of surface material, surface features, and by using other techniques such as electro-wetting (discussed in greater detail below). For example, various dielectrics such as silicon dioxide (SiO₂) or silicon nitride (SiN), metals, and other materials can be used to control surface wettability.

Fabrication of sensor 100 can utilize various semiconductor and MEMS manufacturing techniques. In one embodiment in accordance with the invention, substrate 101 is a silicon wafer substrate that includes multiple material layers (not shown), generally applied using thin-film semiconductor wafer processing techniques. Substrate 101 can be fully or partially covered with dielectric materials and other material layers, e.g., using thin film deposition techniques and/or thick film screening techniques which could comprise either single layer or multi-layer circuit substrates. For example, electrode 102 can be a deposited metal layer that is subsequently covered with a dielectric layer. Metals or other materials may also be deposited to assist in the bonding of substrate 101 to material layer 105, which includes channel walls and inlet features and operates as a cap for the device. Metallic material is also deposited or otherwise applied to material layer 105 to form electrode 108. Material layer 105 can be a wafer of glass, for example, Pyrex®, or another material such as silicon. Bonding material layer 105 to substrate 101 may also be accomplished using any of the above mentioned bonding techniques. For example, the two layers can be joined using anodic bonding, in which case certain regions (not shown) of one or both layers might include a layer of amorphous silicon or polysilicon to facilitate bonding. Suitable output contacts (for connection to measurement and/or control circuitry) can also be provided. In some embodiments in accordance with the invention, various portions of the measurement/control circuitry can be integrated into sensor 100, e.g., fabricated in one or both of material layers 101 and 105.

Numerous different techniques can be used to provide the proper amount (usually a very small amount on the order of tens of micrograms) of liquid metal in the sensor channel. In one technique in accordance with the invention, liquid metal is electroplated on a specially formed receiving surface (e.g., mercury electroplated on an iridium dot). In another technique in accordance with the invention, liquid metal vapor is deposited using selective condensation on specialized nucleation sites (e.g., mercury vapor on gold nucleation sites). In still other techniques, liquid metal is dispensed through nozzles onto a surface. Most of these techniques require the liquid metal to be deposited into an open sensor cavity or onto an exposed surface, and then a cover plate or cavity is bonded to the portion of the switch on which the droplet was formed. Still other techniques in accordance with the invention introduce the liquid metal into the channel after the sensor device is otherwise fabricated, e.g., after layers 101 and 105 are joined. Enclosed (or at least substantially enclosed) sensor cavities can be constructed with suitable channels, and in some instances vents, to allow for the transport of fluidic components to the cavities. This generally allows for fluid transport to cavities that are largely completed. Various techniques, including formation of pressure gradients and electrowetting, can be used to transport fluid along the channels. Vent structures can also be used, but in many cases such structures are subsequently sealed or plugged. Examples of these devices and techniques can be found in U.S. patent application Ser. No. 11/130,846, assigned to the assignee of the present application.

There are also a variety of techniques for measuring the capacitance changes provided by sensor 100 including: charge amplifiers, charge balance techniques, ac bridge impedance measurements, and various oscillator configurations. Additionally, commercially available integrated circuits exist that can be used to measure capacitance changes of a few femtofarads in stray capacitances up to several hundred picofarads. Specialized integrated circuits exist, in part, because of circuit complexity associated with capacitive devices and the influence of parasitic capacitances on sensor performance. Examples of capacitive interface chips including Microsensors Capacitive Readout IC MS3110, Analogue Microelectronics CAV414, Xemics XE2004, and Smartec's Universal Transducer Interface chip. However, in order to reduce the effects of parasitic capacitance and achieve higher performance devices, sensor 100 can be integrated with requisite electronics. In some embodiments in accordance with the invention, multiple separate sensors are integrated into a single device (e.g., and array of sensors) to increase the measured capacitance signal. Still other capacitance measuring techniques can be found in U.S. patent application Ser. No. 11/239,825, assigned to the assignee of the present application.

As noted above, sensor 100 may need to be calibrated so that certain applied pressures are known to provide specific capacitance values. Numerous calibration techniques will be known to those skilled in the art, and such techniques will typically vary, for example, depending on sensor design, sensor materials, fabrication techniques, target fluids to be measured, and the like.

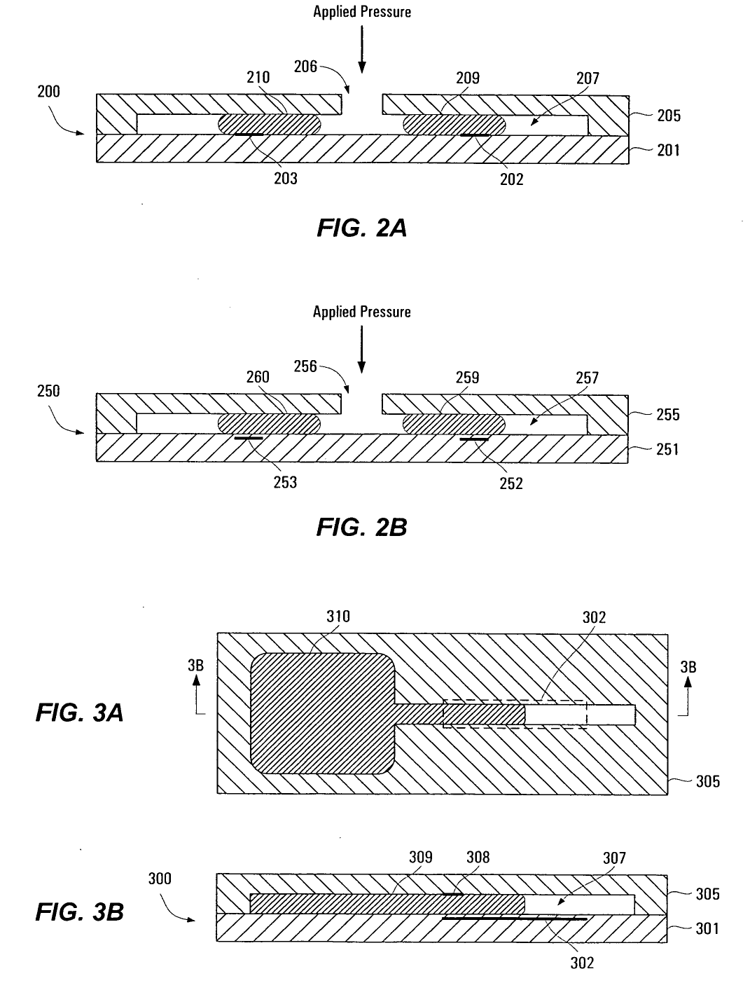

Sensor 100 provides one example of a basic sensor design in accordance with the present invention. FIGS. 1B-1E illustrate several different embodiments of capacitively monitored pressure sensors. In each of the examples illustrated, a channel in the capacitively monitored pressure sensor is designed to include a liquid metal droplet whose movement changes a capacitance. These other embodiments are described below. However, at least some of the design variations, material selections, fabrication techniques, and related sensor features described above in the context of sensor 100 are applicable to the various sensors illustrated in FIGS. 1B-1E, as well as those shown in FIGS. 2A-3B. Consequently, many of these design and fabrication variations are not repeated below in the interest of clarity.

As shown in FIG. 1B, capacitively monitored pressure sensor 120 is formed from two separate material layers 121 and 125. In this case, each of material layers 121 and 125 are separate wafers (or portions thereof) that have been bonded together. For simplicity of illustration, numerous structures and features, such as various additional electrodes, vents, circuitry, etc. used in loading and operating the capacitively monitored pressure sensor, have been omitted from the figure. Capacitively monitored pressure sensor 120 is shown in cross-section. The cross section shown is illustrative of the sensor's length, revealing pressure inlet 126 and fluidic channel 127. Liquid metal droplet 129 is placed within fluidic channel 127, and generally moves in response to an applied pressure through inlet 126 and/or a back-pressure provided by a gas located within channel 127 and between liquid metal droplet 129 and the end wall of the channel. Fluidic channel 127 provides a path along which liquid metal can be introduced and transported. These channels or cavities are typically surrounded on all sides by walls, with the exception of inlet 126.

Capacitively monitored pressure sensor 120 includes two electrodes 122 and 128. For convenience, coupling traces to control circuitry and/or measurement circuitry are not shown. Electrodes 122 and 128 are generally insulated from direct electrical contact with liquid metal droplet 129, e.g., using an intervening insulating layer or the like. Electrodes 122 and 128 represent the two electrodes of a capacitor. As the fluid whose pressure is being measured enters through inlet 126, it pushes liquid metal droplet 129 toward the end of channel 127. In this configuration, the vertical gap (d) between the electrodes does not change, but permittivity of the material between the two electrodes changes as the liquid metal droplet displaces gas in the channel. Sensor 120 is typically calibrated so that the change in capacitance corresponds to a known applied pressure. Electrodes 122 and 128 can be fabricated from any suitable conductor(s) compatible with surrounding materials and fabrication techniques. As with sensor 100, sensor 120 is typically configured so that liquid metal droplet 129 does not travel beyond a certain point, e.g., past the ends of electrodes 122 and 128 closest to the channel end wall.

As shown in FIG. 1C, capacitively monitored pressure sensor 140 is formed from two separate material layers 141 and 145, e.g., separate wafers (or portions thereof) that have been bonded together. For simplicity of illustration, numerous structures and features, such as various additional electrodes, vents, circuitry, etc. used in loading and operating the capacitively monitored pressure sensor, have been omitted from the figure. Capacitively monitored pressure sensor 140 is shown in cross-section. The cross section shown is illustrative of the sensor's length, revealing pressure inlet 146 and fluidic channel 147. Liquid metal droplet 149 is placed within fluidic channel 147, and generally moves in response to an applied pressure through inlet 146 and/or a back-pressure provided by a gas located within channel 147 and between liquid metal droplet 149 and the end wall of the channel. Fluidic channel 147 provides a path along which liquid metal can be introduced and transported. These channels or cavities are typically surrounded on all sides by walls, with the exception of inlet 146.

Capacitively monitored pressure sensor 140 includes two electrodes 142 and 148. For convenience, coupling traces to control circuitry and/or measurement circuitry are not shown. Electrode 148 is formed to at least partially extend into channel 147 and make electrical contact with liquid metal droplet 149, much like electrode 108 in FIG. 1A. Electrode 142 is located on the end wall of channel 147. As shown, electrode 142 extends into channel 147 (e.g., it is at least partially formed on the surface of the channel's end wall, but in alternate embodiments in accordance with the invention, electrode 142 is insulated from possible direct electrical contact with liquid metal droplet 149, e.g., using an intervening insulating layer or the like. Since liquid metal droplet 149 is in contact with electrode 148, the combination operates as a moving electrode in the capacitor formed with electrode 142 and intervening dielectric material, in this case the trapped gas. As the fluid whose pressure is being measured enters through inlet 146, it pushes liquid metal droplet 149 toward the end of channel 147. In this configuration, the gap (d) between the capacitor “plates” changes, while the area A of electrode overlap typically remains constant. In some embodiments in accordance with the invention, the channel width (i.e., the dimension into and out of the page) changes along its length. Such a feature would allow both the gap and the area of overlap (e.g., because of the change in surface area presented by liquid metal droplet 149) of capacitor electrodes to change. Sensor 140 is typically calibrated so that the change in capacitance corresponds to a known applied pressure. Electrodes 142 and 148 can be fabricated from any suitable conductor(s) compatible with surrounding materials and fabrication techniques. For example, depending on the choice of material for liquid metal droplet 149, certain conductors may need to be selected for electrode 148 such that it is not readily absorbed or amalgamated with liquid metal of droplet 149. As with other sensors described above, sensor 140 is typically configured so that liquid metal droplet 149 does not travel beyond a certain point, e.g., to the point where it comes in contact with electrode 142 as shown.

As shown in FIG. 1D, capacitively monitored pressure sensor 160 is formed from two separate material layers 161 and 165. In this case, each of material layers 161 and 165 are separate wafers (or portions thereof) that have been bonded together. For simplicity of illustration, numerous structures and features, such as various additional electrodes, vents, circuitry, etc. used in loading and operating the capacitively monitored pressure sensor, have been omitted from the figure. Capacitively monitored pressure sensor 160 is shown in cross-section. The cross section shown is illustrative of the sensor's length, revealing pressure inlet 166 and fluidic channel 167. Liquid metal droplet 169 is placed within fluidic channel 167, and generally moves in response to an applied pressure through inlet 166 and/or a back-pressure provided by a gas located within channel 167 and between liquid metal droplet 169 and the end wall of the channel. Fluidic channel 167 provides a path along which liquid metal can be introduced and transported. These channels or cavities are typically surrounded on all sides by walls, with the exception of inlet 166.

Capacitively monitored pressure sensor 160 includes a series of electrodes as shown, including those labeled 162-164. For convenience, coupling traces to control circuitry and/or measurement circuitry are not shown. These electrodes are generally insulated from direct electrical contact with liquid metal droplet 169, e.g., using an intervening insulating layer or the like. Any two electrodes in the series of electrodes can represent the electrodes a capacitor whose capacitance is measured as part of sensor operation. Unlike previous examples, none of the electrodes move. Instead the permittivity of the material between fixed electrodes changes. For example, the capacitance measured between electrodes 162 and 163 will have multiple components, e.g., the capacitance between the two facing edges of the electrodes (where the intervening material of layer 161 is the dielectric between these edges), and the capacitance between the faces of the two electrodes, where the various materials (e.g., layer 161, the trapped gas, and liquid metal droplet 169) along the arching path between the two faces provide an effective permittivity for the capacitor. Since this later component changes with the position of liquid metal droplet 169, and thus changes with applied pressure, it is the capacitance of greatest interest. Consequently, the size, shape, and separation of the various electrodes can be designed to minimize or otherwise control the fairly constant capacitance component associated with electrode edges.

This configuration of electrodes offers several different capacitances that can be monitored in response to pressure changes. For example, measuring the capacitance of respective adjacent pairs (e.g., the capacitance between 162 and 163, the capacitance between 163 and 164, etc.) can provide an indication of the location of the leading edge of liquid metal droplet 169. With sufficient numbers of electrodes and proper calibration, such an arrange might allow for relatively imprecise capacitance measurements that still yield accurate pressure measurements. As shown, the capacitance between electrodes 162 and 163 should be quite different from the capacitance between electrodes 163 and 164 because of the location of liquid metal droplet 169. Thus, a course (or in some sense “binary”) measurement simply indicates whether or not the liquid metal droplet edge has passed a given electrode. Still other measurement schemes can use non-adjacent electrode capacitances or differential capacitance measurements. Sensor 160 is typically calibrated so that the change in capacitance corresponds to a known applied pressure. The electrodes illustrated can be fabricated from any suitable conductor(s) compatible with surrounding materials and fabrication techniques. As with other disclosed sensors, sensor 160 is typically configured so that liquid metal droplet 169 does not travel beyond a certain point, e.g., past the end of the last electrode closest to the channel end wall.

Electrodes such as 162-164 can also be used for electrowetting, e.g., for loading the liquid metal droplet, for constraining its movement, for resetting its position, and the like. As an illustration of the electrowetting effect, placement of a liquid droplet on a non-wetting surface causes the droplet to maintain a high contact angle. If the liquid droplet is polarizable and/or at least slightly electrically conductive, an electrical potential applied between the droplet and an insulated electrode underneath the droplet, reduces the droplet's contact angle with the surface on which it rests. Reducing the droplet's contact angle improves wetting with respect to the surface. The reduction in contact angle occurs because electrostatic forces try to increase the capacitance and stored energy in the droplet/insulator/electrode system. The effect depends on a number of factors including applied voltage (and thus electrode configuration), insulator parameters (e.g., thickness and dielectric constant), and liquid droplet properties. However, with proper selection of system properties, relatively large and reversible contact angle changes are achieved. In some embodiments in accordance with the invention, certain electrodes can be grounded while others are maintained at a higher voltage. In other embodiments in accordance with the invention, electrodes are alternately charged without the use of a ground electrode. This technique generally requires the control electrode pitch to be sufficiently smaller than the liquid metal droplet size. In addition to affecting the local wettability where the droplet rests, application of an electric field (e.g., on one side of the droplet) can induce forces on the liquid metal droplet, causing actuation.

Additional electrodes (e.g., in layer 165) can be included in support of some electro-wetting configurations. Numerous other electrode arrangements can be implemented. For example, ground electrodes can be insulated from, or in direct electrical contact with, the liquid metal droplet. Ground electrodes can be placed in the same material layer as the control electrodes. Moreover, both material layers can contain control electrodes, e.g., facing pairs of electrodes with opposite polarity when energized. In general, such actuation can be achieved as long as the potential of the liquid metal droplet is different from at least one of the electrodes. Thus, electrowetting devices and techniques can be used in conjunction with any of the sensors described, and need not be used only in sensors such as sensor 160.

As shown in FIG. 1E, capacitively monitored pressure sensor 180 is formed from two separate material layers, 181 and 185. In this case, each of material layers are separate wafers (or portions thereof) that have been bonded together. For simplicity of illustration, numerous structures and features, such as various additional electrodes, vents, circuitry, etc. used in loading and operating the capacitively monitored pressure sensor, have been omitted from the figure. Capacitively monitored pressure sensor 180 is shown from above, and the illustrated cross section shows the sensor's length and width, revealing an area 186 corresponding to a pressure inlet and a fluidic channel 187. Liquid metal droplet 189 is placed within fluidic channel 187, and generally moves in response to an applied pressure through the inlet and/or a back-pressure provided by a gas located within channel 187 and between liquid metal droplet 189 and the end wall of the channel. Fluidic channel 187 provides a path along which liquid metal can be introduced and transported. These channels or cavities are typically surrounded on all sides by walls, with the exception of the inlet.

Capacitively monitored pressure sensor 180 includes two electrodes (182 and 183) located beneath the floor of channel 187. For convenience, coupling traces to control circuitry and/or measurement circuitry are not shown. These electrodes are generally insulated from direct electrical contact with liquid metal droplet 189, e.g., using an intervening insulating layer or the like. The two electrodes represent the electrodes of a capacitor whose capacitance is measured as part of sensor operation. As with sensor 160 of FIG. 1D, none of the electrodes of sensor 180 move. Instead the permittivity of the material between fixed electrodes changes. The capacitance measured between electrodes 182 and 183 will have multiple components, e.g., the capacitance between the two facing edges of the electrodes (where the intervening material of layer 181 is the dielectric between these edges), and the capacitance between the faces of the two electrodes, where the various materials (e.g., layer 181, the trapped gas, and liquid metal droplet 189) along the arching path between the two faces provide an effective permittivity for the capacitor. Since this later component changes with the position of liquid metal droplet 189, and thus changes with applied pressure, it is the capacitance of greatest interest. Consequently, the size, shape, and separation of the electrodes can be designed to minimize or otherwise control the fairly constant capacitance component associated with electrode edges. Sensor 180 is typically calibrated so that the change in capacitance corresponds to a known applied pressure. The electrodes illustrated can be fabricated from any suitable conductor(s) compatible with surrounding materials and fabrication techniques. As with other disclosed sensors, sensor 180 is typically configured so that liquid metal droplet 189 does not travel beyond a certain point, e.g., past the end of the last electrode closest to the channel end wall.

FIGS. 2A and 2B illustrate still other embodiments in accordance with the invention of liquid metal capacitively monitored pressure sensors. These sensors use two channels connected at the end and exposed to the monitored environment. As shown in FIG. 2A, capacitively monitored pressure sensor 200 is formed from two separate material layers 201 and 205, e.g., separate wafers (or portions thereof) that have been bonded together. For simplicity of illustration, numerous structures and features, such as various additional electrodes, vents, circuitry, etc. used in loading and operating the capacitively monitored pressure sensor, have been omitted from the figure. Capacitively monitored pressure sensor 200 is shown in cross-section, which is illustrative of the sensor's length, revealing pressure inlet 206 and fluidic channel 207, which has two channel paths separated by the inlet. Liquid metal droplets 209 and 210 are placed within fluidic channel 207, and generally move in response to an applied pressure through inlet 206 and/or a back-pressure provided by a gas located within channel 207 and between the liquid metal droplets and their respective channel end walls. Fluidic channel 207 also provides a path along which liquid metal can be introduced and transported. These channels or cavities are typically surrounded on all sides by walls, with the exception of inlet 206.

Capacitively monitored pressure sensor 200 includes two electrodes 202 and 203. For convenience, coupling traces to control circuitry and/or measurement circuitry are not shown. Electrodes 202 and 203 are formed to at least partially extend into channel 207 and make electrical contact with corresponding liquid metal droplets 209 and 210, much like electrode 108 in FIG. 1A. Since each liquid metal droplet is in contact with a corresponding electrode, the combination operates as two plates of a capacitor, where both plates move, i.e., their separation d changes, in response to the applied pressure, thereby changing the capacitance of the capacitor. In some embodiments in accordance with the invention channel 207 has a uniform height and width (at least in those portions of the channel where the droplets move), and thus the area A of electrode overlap typically remains constant. In other embodiments in accordance with the invention, the channel width and/or height changes along its length. Such a feature would allow both the gap and the area of overlap (e.g., because of the change in surface area presented by the liquid metal droplets) of capacitor electrodes to change. Sensor 200 is typically calibrated so that the change in capacitance corresponds to a known applied pressure. Electrodes 202 and 203 can be fabricated from any suitable conductor(s) compatible with surrounding materials and fabrication techniques. For example, depending on the choice of material for the liquid metal droplets, certain conductors may need to be selected for the electrodes such that they are not readily absorbed or amalgamated with the liquid metal droplets. As with other sensors described above, sensor 140 is typically configured so that liquid metal droplets does not travel beyond a certain point, e.g., to the point where they are no longer in contact with their corresponding electrodes.

As shown in FIG. 2B, capacitively monitored pressure sensor 250 is similar in configuration to sensor 200. Sensor 250 is formed from two separate material layers 201 and 205, e.g., separate wafers (or portions thereof) that have been bonded together. For simplicity of illustration, numerous structures and features, such as various additional electrodes, vents, circuitry, etc. used in loading and operating the capacitively monitored pressure sensor, have been omitted from the figure. Capacitively monitored pressure sensor 250 includes pressure inlet 256 and fluidic channel 257, which has two channel paths separated by the inlet. Liquid metal droplets 259 and 260 are placed within fluidic channel 257, and generally move in response to an applied pressure through inlet 256 and/or a back-pressure provided by a gas located within channel 257 and between the liquid metal droplets and their respective channel end walls. These channels or cavities are typically surrounded on all sides by walls, with the exception of inlet 256.

Capacitively monitored pressure sensor 250 includes two electrodes 252 and 253. For convenience, coupling traces to control circuitry and/or measurement circuitry are not shown. Electrodes 252 and 253 are generally insulated from direct electrical contact with liquid metal droplets 259 and 260, e.g., using an intervening insulating layer or the like. The two electrodes represent the electrodes of a capacitor whose capacitance is measured as part of sensor operation, but none of the electrodes of sensor 250 move. Instead the permittivity of the material between fixed electrodes changes. The capacitance measured between electrodes 252 and 253 will have multiple components, e.g., the capacitance between the two facing edges of the electrodes (where the intervening material of layer 251 is the dielectric between these edges), and the capacitance between the faces of the two electrodes, where the various materials (e.g., layer 251, the incoming fluid whose pressure is being sensed, and the liquid metal droplets) along the path between the two faces provide an effective permittivity for the capacitor. Since this later component changes with the position of liquid metal droplets, and thus changes with applied pressure, it is the capacitance of greatest interest. Consequently, the size, shape, and separation of the electrodes can be designed to minimize or otherwise control the fairly constant capacitance component associated with electrode edges. In the example illustrated, the separation d of theses edges is relatively large, so that the capacitance may be comparatively small. Like sensor 200, in some embodiments in accordance with the invention channel 257 has a uniform height and width, while in other embodiments in accordance with the invention, the channel width and/or height changes along its length. Sensor 250 is typically calibrated so that the change in capacitance corresponds to a known applied pressure. The electrodes illustrated can be fabricated from any suitable conductor(s) compatible with surrounding materials and fabrication techniques. As with other disclosed sensors, sensor 250 is typically configured so that the liquid metal droplets do not travel beyond a certain point, e.g., past the point where each of the electrodes is not completely underneath its corresponding droplet.

In yet another embodiment in accordance with the invention, sensor designs like that of FIGS. 2A and 2B are employed, but unlike those sensors, the liquid metal droplets generally pinned in place by utilizing regions of low contact angle surfaces bordered by regions with high contact angle surfaces. Thus, the applied pressure change causes changes in the meniscuses of the liquid metal droplets, thereby causing changes in the capacitance without displacing the droplets.

Many of the devices and techniques described above can be used for sensors other than pressure sensors. FIGS. 3A-3B illustrate a capacitively monitored temperature sensor that can be further implemented using the architectures illustrated and described above. FIG. 3A illustrates a partial top view of a capacitively monitored temperature sensor 300, shown in cross section in FIG. 3B. Capacitively monitored temperature sensor 300 is formed from two separate material layers 301 and 305, e.g., separate wafers (or portions thereof) that have been bonded together. For simplicity of illustration, numerous structures and features, such as various additional electrodes, vents, circuitry, etc. used in loading and operating the capacitively monitored temperature sensor, have been omitted from the figure. Capacitively monitored temperature sensor 300 includes a fluidic cavity (typically sealed after final assembly and/or loading of the liquid metal) having a channel portion 307 and a reservoir portion 310.

Channel 307 typically has a smaller cross-section than reservoir 310, providing for greater movement of the liquid metal 309 due to thermal expansion and contraction of the liquid metal. Sensor 300 is typically fabricated in such a way as to maintain a low pressure in the unoccupied portion of channel 307, thereby limiting back-pressure that might slow (increase) the expansion (contraction) of the liquid metal in response to an increase (decrease) in sensed temperature.

Capacitively monitored temperature sensor 300 includes two electrodes 308 and 302. For convenience, coupling traces to control circuitry and/or measurement circuitry are not shown. Electrode 308 (not shown in FIG. 3A) is formed to at least partially extend into channel 307 and make electrical contact with liquid metal droplet 309. Electrode 302 is generally insulated from direct electrical contact with liquid metal droplet 309, e.g., using an intervening insulating layer or the like. As the temperature around the sensor increases, the liquid metal expands toward the end of channel 307. Since liquid metal droplet 309 is in contact with electrode 308, the combination operates as a moving electrode in the capacitor formed with electrode 302 and intervening dielectric material. In this configuration, the vertical gap (d) between the electrodes does not change, but the area A of overlap between the electrodes does change with temperature change. Sensor 300 is typically calibrated so that a change in capacitance corresponds to a known applied temperature. Electrodes 302 and 308 can be fabricated from any suitable conductor(s) compatible with surrounding materials and fabrication techniques. For example, depending on the choice of material for liquid metal droplet 309, certain conductors may need to be selected for electrode 308 such that it is not readily absorbed or amalgamated with liquid metal of droplet 309.

As with the other sensors described in the present application, wettability of the channel and reservoir surfaces can be important to proper sensor operation. However, temperature sensor 300 has competing needs that impact the wettability characteristics to be chosen. For example, fairly high contact angles between the liquid metal and the cavity walls are desirable because they enable free movement of the liquid metal. On the other hand, if the liquid metal has too much freedom to move, the chances of it breaking into multiple slugs increases, leading to improper sensor operation (e.g., unreliable changes in capacitance). Consequently, different portions of the cavity may have different wettability conditions. Reservoir 310 can have fairly wetting surfaces to keep the body of the liquid metal slug in the reservoir. In general, the reservoir exists to increase the effect of the expansion (contraction) by increasing (decreasing) the volume of liquid metal. At the opposite end of channel 307, one or more surfaces can be very non-wetting to reduce the chances that the liquid metal slug breaks into multiple slugs during the process of moving in the channel. Areas in between can have an intermediate wettability to allow adequate movement of the liquid metal, or there can be an abrupt wettability boundary as desired. Still other variations will be known to those skilled in the art. As noted above, various techniques can be used to adjust surface wettability throughout the sensor.

As will be understood to those skilled in the art, some or all of the capacitive sensing schemes described above in connection with FIGS. 1A-1E can be used in a temperature sensor following the basic design of FIGS. 3A-3B. Moreover, other types of sensors can be developed using similar designs and techniques. For example, similar sensors can be used to measure applied force or acceleration. Additionally, although the discussion above has generally focused on the use of liquid metals, other conducting liquids and even non-conducting liquids can be used. For example, the architectures illustrated in FIGS. 1B, 1D, 1E, and 2B do not rely on ohmic contact between a capacitor electrode and the transducing medium. Thus, suitable liquid dielectrics can be employed to provide requisite changes in capacitance in response to the input stimulus. Petroleum oils are the most common insulating liquids, however, fluorocarbons, silicones, and organic esters including castor oil are also materials with high permittivity. High permittivity need not be a requirement. In general, the important factors in liquid selection are: (1) the liquid's compatibility with the device and its intended environment, and (2) providing measurable changes in capacitance of the capacitive structure.

Those skilled in the art will readily recognize that a variety of different types of components and materials can be used in place of the components and materials discussed above. Moreover, the description of the embodiments in accordance with the invention set forth herein is illustrative and is not intended to limit the scope of the invention as set forth in the following claims. Variations and modifications of the embodiments disclosed herein may be made based on the description set forth herein, without departing from the scope and spirit of the invention as set forth in the following claims.

What is claimed is:

1. An apparatus comprising:
a device substrate;
a sensor cavity at least partially formed by the device substrate;
a portion of liquid located in the sensor cavity and configured to be displaced in response to a stimulus;
a first electrode; and
a second electrode, wherein at least the first electrode, the second electrode, and the portion of liquid form a capacitor whose capacitance changes in response to displacement of the portion of liquid.

2. The apparatus of claim 1 further comprising a second device substrate coupled to the device substrate, wherein a portion of the second device substrate further defines the sensor cavity.

3. The apparatus of claim 1 further comprising:
an inlet coupled to the sensor cavity and configured to allow a fluid to come into contact with the portion of liquid.

4. The apparatus of claim 1 wherein the sensor cavity is sealed.

5. The apparatus of claim 1 wherein the portion of liquid located in the sensor cavity further comprises at least one of: an electrically conductive fluid, a liquid metal, a liquid metal alloy, and a liquid dielectric.

6. The apparatus of claim 1 wherein the portion of liquid located in the sensor cavity further comprises a plurality of separate portions of liquid, and at least two of the plurality of separate portions of liquid are configured to be displaced in response to the stimulus.

7. The apparatus of claim 1 further comprising:
a gas confined between the portion of liquid located in the sensor cavity and a closed portion of the sensor cavity.

8. The apparatus of claim 7 wherein the gas is one of an inert gas and a reducing gas.

9. The apparatus of claim 1 wherein the first electrode is at least partially exposed to a surface of the sensor cavity, and wherein the portion of liquid is located to make contact with a portion of the first electrode at least partially exposed to the surface of the sensor cavity.

10. The apparatus of claim 1 wherein the first electrode and the second electrode are electrically insulated from the portion of liquid located in the sensor cavity.

11. The apparatus of claim 1 wherein at least one of the first electrode, the second electrode, a third electrode is positioned in proximity to the sensor cavity, and wherein the at least one of the first electrode, the second electrode, the third electrode is configured to affect the wettability of a surface of the sensor cavity.

12. The apparatus of claim 1 further comprising:
a first sensor cavity surface at least partially defining the sensor cavity, wherein the first sensor cavity surface includes a first region having a first wettability and a second region having a second wettability.

13. The apparatus of claim 1 wherein the stimulus further comprises at least one of a temperature change, a fluid flow, an acceleration, and an applied force.

14. A method comprising:
providing a first substrate;
forming at least a portion of a sensor cavity in the first substrate;
depositing a portion of a liquid into the at least a portion of the sensor cavity;
locating the portion of the liquid in proximity to at least one electrode such that movement of the portion of the liquid with respect to the at least one electrode causes a change in capacitance of a capacitor including the portion of the liquid and the at least one electrode;
providing a conduit for a stimulus to cause movement of the portion of the liquid.

15. The method of claim 14 further composing:
etching at least one of the first substrate and a second substrate, and bonding the first substrate to the second substrate.

16. The method of claim 14 further comprising:
forming the at least one electrode in at least one of the first substrate and a second substrate.

17. The method of claim 14 wherein the depositing the portion of the liquid into the at least a portion of the sensor cavity further comprises at least one of:
electroplating the portion of the liquid onto a surface of the sensor cavity;
condensing vapor on the surface of the sensor cavity; and
injecting the portion of the liquid into the sensor cavity.

18. The method of claim 14 wherein the portion of liquid located further comprises at least one of: an electrically conductive fluid, a liquid metal, a liquid metal alloy, and a liquid dielectric.

19. The method of claim 14
confining a gas between the portion of liquid and a closed portion of the sensor cavity.

20. An apparatus comprising:
a means for providing retaining a portion of a liquid;
a means for applying a stimulus to be sensed to the portion of the liquid;
a means for transporting the portion of the liquid in response to the stimulus and with respect to at least one electrode; and
a means for measuring a capacitance maintained by a capacitor formed at least in part by the at least one electrode and the portion of the liquid.
